(19) United States
(12) Patent Application Publication
(10) Pub. No.: US 2015/0313215 A1
(43) Pub. Date: Nov. 5, 2015

(54) PESTICIDAL MIXTURES

(71) Applicant: SYNGENTA CROP PROTECTION LLC, Greensboro, NC (US)

(72) Inventors: Stephen Wilson Skillman, Basel (CH); Christoph Grimm, Stein (CH); Ulrich Johannes Haas, Stein (CH)

(73) Assignee: SYNGENTA CROP PROTECTION LLC, Greensboro, NC (US)

(21) Appl. No.: 14/797,605

(22) Filed: Jul. 13, 2015

Related U.S. Application Data
(62) Division of application No. 13/634,903, filed on Nov. 27, 2012, now abandoned.

(30) Foreign Application Priority Data
Mar. 24, 2010 (EP) 10157596.7

(51) Int. Cl. A01N 35/06; A01N 37/42; A01N 43/56

(52) U.S. Cl. CPC A01N 35/06; A01N 43/56; A01N 37/42

(57) ABSTRACT

Mixtures comprising cis-jasmone and an agrochemical active ingredient are useful in agriculture.

### CROSS-RELATED INFORMATION

This is a divisional application of U.S. application Ser. No. 13/634,903 filed on Nov. 27, 2012 which is a 371 of International Application No. PCT/EP2011/054395 filed Mar. 23, 2011, which claims priority to EP 10157596.7 filed Mar. 24, 2010, the contents of which are incorporated herein by reference.

The present invention relates to mixtures of cis-jasmone and to methods of using the mixtures in the field of agriculture.

WO 2000/005964 and WO09/060165 disclose the use of mixtures containing cis-jasmone. The present invention provides mixtures comprising cis-jasmone and a component B.

Component B is an agrochemical active ingredient. Suitable agrochemical active ingredients include insecticides, acaricides, nematocides, molluscicides, fungicides, herbicides, and plant growth regulators.

It has now been found, surprisingly, that the agrochemical active ingredient mixture according to the invention can extend the range of action of the agrochemical active ingredient e.g. by achieving a synergistic effect. Thus, the rates of application of the components are lowered whilst the action remains equally good. Secondly, the active ingredient mixture still achieves a high degree of pest or weed control, sometimes even where the two individual components have become totally ineffective in such a low application rate range. This allows increased safety in use.

However, besides the synergistic action with respect to pest control, the pesticidal compositions according to the invention can have further surprising advantageous properties which can also be described, in a wider sense, as synergistic activity. Examples of such advantageous properties that may be mentioned are: a broadening of the spectrum of pest control to other pests, for example to resistant strains; a reduction in the rate of application of the active ingredients; adequate pest control with the aid of the compositions according to the invention, even at a rate of application at which the individual compounds are totally ineffective; advantageous behaviour during formulation and/or upon application, for example upon grinding, sieving, emulsifying, dissolving or dispensing; increased storage stability; improved stability to light; more advantageous degradability; improved toxicological and/or ecotoxicological behaviour; improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination; or any other advantages familiar to a person skilled in the art.

Certain methods of enhancing crops are described in the literature. These methods are usually based on conventional fertilising but some also rely on agrochemicals such as insecticides. For example, fipronil has been reported e.g. to enhance overall root system and root hair development, increase tiller number and productivity, increase photosynthetic capacity (plant greenness), increase leaf area and plant height and stimulate early flowering and grain maturation.

It has now been found that the inventive mixtures of the present invention show crop enhancement effects.

The components B are known, e.g. from “The Pesticide Manual”, Fifteenth Edition, Edited by Clive Tomlin, British Crop Protection Council.

The combinations according to the invention may also comprise more than one of the active components B, if, for example, a broadening of the spectrum of pest control is desired. For instance, it may be advantageous in the agricultural practice to combine two or three components B with cis-jasmone. The mixtures of the invention may also comprise other active ingredients in addition to cis-jasmone and component B.

Preferably component B is a compound selected from

a) a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;

b) an organophosphate selected from the group consisting of acephate, profenofos, triazophos, methamidophos, dimethoate, chlorpyrifos, pirimiphos-methyl, pirimiphos-ethyl, fenitrothion, fosthiazate;

c) a carbamate selected from the group consisting of pirimicarb, triazamate, carbosulfan, bendiocarb, fenobucarb, propoxur, methomyl and oxamyl;

d) a benzoyl urea selected from the group consisting of hexaflumuron, flufenoxuron, lufenuron and chlorfluazuron;

e) an organic tin compound selected from the group consisting of cyhexatin, fenbutatin oxide and azocyclotin;

f) a pyrazole selected from the group consisting of tebufenpyrad and fenpyroximate;

g) a macrolide selected from the group consisting of abamectin, emamectin (e.g. emamectin benzoate), ivermectin, milbemycin, spinosad, azadirachtin and spinetoram;

h) an organochlorine compound selected from the group consisting of endosulfan (in particular alpha-endosulfan),

j) a fumigant agent selected from the group consisting of chloropicrin, dichloropropane, methyl bromide and metam;

k) a neonicotinoid compound selected from the group consisting of imidacloprid, thiacloprid, acetamiprid, nitenpyram, dinotefuran, thiamethoxam, clothianidin, nithiazine and flonicamid;

l) a diacylhydrazine selected from the group consisting of tebufenozide, chromafenozide and methoxyfenozide;

m) a diphenyl ether selected from the group consisting of pyriproxyfen;

n) indoxacarb;

o) chlorfenapyr;

p) pymetrozine;

q) spirotetramat, spirodiclofen and spiromesifen;

r) a diamide selected from the group consisting of flubendiamide, chlorantraniliprole (Rynaxypyr®) and cyantraniliprole;

s) sulfoxaflor;

t) metaflumizone;

u) fipronil and ethiprole;

v) pyrifluqinazon; and

w) buprofezin

In one embodiment of the invention component B is a compound selected from
pymetrozine;
profenofos, methamidophos, chlorpyrifos, pirimiphos-methyl, fosthiazate lambda-cyhalothrin, tefluthrin, natural pyrethrin,
abamectin, emamectin benzoate, spinosad, azadirachtin and spinetoram;
a diamide selected from the group consisting of flubendiamide, chlorantraniliprole (Rynaxypyr®) and cyantraniliprole;
a neonicotinoid compound selected from the group consisting of imidacloprid, thiacloprid, acetamiprid, nitenpyram, dinotefuran, thiamethoxam, clothianidin, nithiazine and flonicamid; and
spirotetramat, spirodiclofen and spiromesifen.

Preferably component B is a compound selected from the group consisting of abamectin, cyantraniliprole, emamectin, lambda cyhalothrin, pymetrozine, spirotetramat, thiamethoxam, and chlorantraniliprole.

More preferably component B is a compound selected from the group consisting of

abamectin, chlorpyrifos, cyantraniliprole, emamectin, lambda cyhalothrin, pymetrozine, spirotetramat, and thiamethoxam.

The invention also includes the following combinations:

Cis-jasmone and abamectin.

Cis-jasmone and cyantraniliprole.

Cis-jasmone and emamectin.

Cis-jasmone and cyhalothrin.

Cis-jasmone and lambda cyhalothrin.

Cis-jasmone and gamma cyhalothrin.

Cis-jasmone and pymetrozine.

Cis-jasmone and spirotetramat.

Cis-jasmone and thiamethoxam.

Cis-jasmone and chlorantraniliprole.

Cis-jasmone and profenofos.

Cis-jasmone and phosthiazate

Cis-jasmone and methamidophos.

Cis-jasmone and spinosad.

Cis-jasmone and spinetoram.

Cis-jasmone and flonicamid.

Cis-jasmone and indoxacarb.

Cis-jasmone and spirodiclofen.

Cis-jasmone and spiromesifen.

Cis-jasmone and sulfoxaflor.

Cis-jasmone and fipronil.

Cis-jasmone and imidacloprid.

Cis-jasmone and thiacloprid.

Cis-jasmone and acetamiprid.

Cis-jasmone and nitenpyram.

Cis-jasmone and dinotefuran.

Cis-jasmone and clothianidin.

Cis-jasmone and nithiazine.

Cis-jasmone and pyriproxyfen.

Cis-jasmone and buprofezin.

Cis-jasmone and pyrifluqinazon.

Cis-jasmone, thiamethoxam and cyantraniliprole.

Cis-jasmone, thiamethoxam and chlorantraniliprole.

Cis-jasmone, thiamethoxam and lambda-cyhalothrin.

Cis-jasmone, cyantraniliprole and abamectin.

Examples of fungicidal compounds which may suitably be used as component B are (E)-N-methyl-2-[2-(2,5-dimethylphenoxymethyl)phenyl]-2-methoxy-iminoacetamide (SSF-129), 4-bromo-2-cyano-N,N-dimethyl-6-trifluoromethylbenzimidazole-1-sulfonamide, α-[N-(3-chloro-2,6-xylyl)-2-methoxyacetamido]-γ-butyrolactone, 4-chloro-2-cyano-N,N-dimethyl-5-p-tolylimidazole-1-sulfonamide (IKF-916, cyamidazosulfamid), 3-5-dichloro-N-(3-chloro-1-ethyl-1-methyl-2-oxopropyl)-4-methylbenzamide (RH-7281, zoxamide), N-allyl-4,5,-dimethyl-2-trimethylsilylthiophene-3-carboxamide (MON65500), N-(1-cyano-1,2-dimethylpropyl)-2-(2,4-dichlorophenoxy)propionamide (AC382042), N-(2-methoxy-5-pyridyl)-cyclopropane carboxamide, N-[(1RS,4SR)-9-(Dichloromethylidene)-1,2,3,4-tetrahydro-1,4-methanonaphthalen-5-yl]-3-(difluoromethyl)-1-methyl-1H-pyrazole-4-carboxamide, acibenzolar (CGA245704), alanycarb, aldimorph, anilazine, azaconazole, azoxystrobin, benalaxyl, benomyl, bi-loxazol, bixafen, bitertanol, blasticidin S, boscalid, bromuconazole, bupirimate, butylamine, captafol, captan, carbendazim, carbendazim chlorhydrate, carboxin, carpropam id, carvone, CGA41396, CGA41397, chinomethionate, chloraniformethan, chlorothalonil, chlorozolinate, clozylacon, copper containing compounds such as copper oxychloride, copper oxyquinolate, copper sulfate, copper tallate and Bordeaux mixture, cyflufenamid, cymoxanil, cyproconazole, cyprodinil, debacarb, di-2-pyridyl disulfide 1,1′-dioxide, dichlofluanid, diclocymet, diclomezine, dicloran, diethofencarb, difenocon-azole, difenzoquat, diflumetorim, 0,0-di-iso-propyl-S-benzyl thiophosphate, dimefluazole, dimetconazole, dimethomorph, dimethirimol, diniconazole, dinocap, dithianon, dodecyl dimethyl ammonium chloride, dodemorph, dodicin, dodine, doguadine, edifenphos, epoxiconazole, ethamoxam, ethirimol, ethyl-(Z)—N-benzyl-N-([methyl(methyl-thioethylideneaminooxycarbonyl)amino]thio)-β-alaninate, etridiazole, famoxadone, fenamidone (RPA407213), fenarimol, fenbuconazole, fenfuram, fenhexamid (KBR2738), fenoxanil, fenpiclonil, fenpropidin, fenpropimorph, fentin acetate, fentin hydroxide, ferbam, ferimzone, fluazinam, fludioxonil, flumetover, fluoroimide, fluquinconazole, flusilazole, flutolanil, flutriafol, fluxapyroxad, folpet, fuberidazole, furalax-yl, furametpyr, furfural, guazatine, hexaconazole, hydroxyisoxazole, hymexazole, imazalil, imibenconazole, iminoctadine, iminoctadine triacetate, ipconazole, iprobenfos, iprodione, iprovalicarb (SZX0722), isopropanyl butyl carbamate, isoprothiolane, isopyrazam, isotianil, kasugamycin, kresoxim-methyl, leptomycin, LY186054, LY211795, LY248908, mancozeb, mandipropamid, maneb, mefenoxam, mepanipyrim, mepronil, metalaxyl, metconazole, metiram, metiram-zinc, metominostrobin, metsulfovax, myclobutanil, neoasozin, nickel dimethyldithiocarbamate, nitrothal-isopropyl, nuarimol, OCH, ofurace, organomercury compounds, oxadixyl, oxasulfuron, oxolinic acid, oxpoconazole, oxycarboxin, pefurazoate, penconazole, pencycuron, penthiopyrad, phenazin oxide, phosetyl-Al, phosphorus acids, phthalide, picoxystrobin (ZA1963), poly-oxin D, polyram, probenazole, prochloraz, procymidone, propamocarb, propiconazole, propineb, propionic acid, prothiaconazole, pyrazophos, pyrifenox, pyrimethanil, pyroquilon, pyroxyfur, pyrrolnitrin, quaternary ammonium compounds, quinazamid, quinomethionate, quinoxyfen, quintozene, silthiofam, sipconazole (F-155), sodium pentachlorophenate, spiroxamine, streptomycin, sulfur, tebuconazole, tecloftalam, tecnazene, tetraconazole, thiabendazole, thifluzamid, 2-(thiocyanomethylthio)benzothiazole, thiophanate-methyl, thiram, timibenconazole, tolclofos-methyl, tolylfluanid, triadimefon, triadimenol, triazbutil, triazoxide, tricyclazole, tricyclic amine derivatives as disclosed in WO 07/48556, tridemorph, trifloxystrobin (CGA279202), triforine, triflumizole, triticonazole, validamycin A, valifenalate, vapam, vinclozolin, xiwojunan, zineb and ziram.

The invention also includes the following combinations:
Cis-jasmone and N-[(1RS,4SR)-9-(Dichloromethylidene)-1,2,3,4-tetrahydro-1,4-methanonaphthalen-5-yl]-3-(difluoromethyl)-1-methyl-1H-pyrazole-4-carboxamide.
Cis-jasmone, N-[(1RS,4SR)-9-(Dichloromethylidene)-1,2,3,4-tetrahydro-1,4-methanonaphthalen-5-yl]-3-(difluoromethyl)-1-methyl-1H-pyrazole-4-carboxamide, and azoxystrobin.

Examples of herbicides which may suitably be used as component B are:
A. 1,2,4-triazin-5-ones such as metamitron and metribuzin
B. dimethylpyrazoles such as benzofenap, pyrazolynate (pyrazolate) and pyrazoxyfen.
C. acylanilides such as propanil
D. amide herbicides such as benfluamid, bromobutide, carbetamide, flufenacet, isoxaben, naproanilide, napropamide, naptalam, propyzamide and tebutam
E. amino acids and salts and esters thereof, such as bialaphos and salts and esters thereof, glufosinate salts and esters thereof, glyphosate and salts and esters thereof, and sulfosate.
F. aryloxypropionates, including the optically active isomers thereof, such as clodinafop-propargyl, cyhalofop-butyl, diclofop & esters thereof e.g. methyl ester, fenoxaprop & esters thereof eg ethyl ester, fluazifop-butyl, haloxyfop and esters thereof, propaquizafop, quizalofop and esters thereof and quizalofop-p-tefuryl
G. arylanilides such as diflufenican, flamprop, flamprop-M and esters thereof
H. arylureas such as chlorbromuron, chlorotoluron, daimuron (dymron), dimefuron, diuron, fenuron, fluometuron, isoproturon, isouron, linuron, methabenzthiazuron, methyldymron, metobromuron, metoxuron, monolinuron, neburon and tebuthiuron
I. benzo-2,1,3-thiadiazin-4-one-dioxides such as bentazone
J. benzoic acids such as 2,3,6-trichlorobenzoic acid, chloramben and dicamba
K. bipyridyliums such as diquat and salts thereof, and paraquat and salts thereof.
L. carbamates such as chlorpropham and propham, and phenylcarbamoyloxyphenyl carbamates such as desmedipham and phenmedipham
M. acetamides such as acetochlor, alachlor, butachlor, dimethachlor, dimethenamid and isomers thereof, metazachlor, metolachlor and isomers thereof, pretilachlor, propachlor, propisochlor and thenylchlor.
N. cyclohexanediones such as alloxydim and salts thereof, butroxydim, clethodim, cycloxydim, sethoxydim, tepraloxydim and tralkoxydim.
O. dihalobenzonitriles such as dichlobenil
P. dinitrophenols such as dinoterb and dintro ortho-cresol (DNOC)
Q. diphenyl ethers such as aciflurofen and salts and esters thereof, aclonifen, bifenox, chlomethoxyfen, chlornitrofen, fluroglycofen or salts or ester thereof, fomesafen, lactofen and oxyfluorfen.
R. dinitroanilines such as dinitramine, ethalfluralin, fluchloralin, oryzalin, pendimethalin, prodiamine and trifluralin.
S. haloalkanoic herbicides such as dalapon and trichloroacetic acid and salts thereof.
T. hydroxybenzonitrile (HBN) herbicides such as bromoxynil and ioxynil, and HBN precursors such as bromofenoxim
U. hormone herbicides such as 2,4,5-trichlorophenoxyacetic acid, 2,4-dichlorophenoxyacetic acid, 2,4-dichlorophenoxybutyric acid, clopyralid, dichlorprop & dichlorprop-p, fluroxypyr, 4-chloro-2-methoxyacetic acid (MCPA), MCPA-thioethyl, 4-(4-chloro-2-methylphenoxy)butyric acid (MCPB), mecoprop & mecoprop-p, picloram, thiazopyr and triclopyr.
V. imidazolinones such as imazapic, imazamox, imazamethabenz-methyl, imazapyr & isopropylammonium salts thereof, imazaquin and imazethapyr.
W. methyl isothiocyanate precursors such as dazomet.
X. miscellaneous herbicides such as ammonium sulfamate, asulam, azafenidin, benazolin, benzobicyclon/benbiclon, cinmethylin, clomazone, difenzoquat & salts thereof eg methyl sulphate salt, diflufenzopyr-sodium (SAN-835H), dimethipin, dimexyflam, diphenamid, dithiopyr, epoprodan, ethofumesate, etobenzanid, fluazolate, fentrazamide, flucarbazone, flumiclorac-pentyl, flumioxazin, flupoxam, flurenol-butyl, flurochloridone, flurtamone, fluthiacet-methyl, hexazinone, mefenacet, oxadiazon, oxaziclomefone, pentoxazone, pyraflufen-ethyl, pyridatol/pyridafol, pyridate, isoxachlortole, isoxaflutole and sodium chlorate.
Y. organoarsenical herbicides such as disodium methylarsonate (DSMA) and monosodium methylarsonate (MSMA)
Z. organophosphorus herbicides such as anilofos and fosamine-sodium
AA. phosphorothioates such as butamifos, bensulide and piperophos
BB. pyridazinones such as chloridazon and norflurazon
CC. pyridones such as fluridone
DD. pyrimidinyloxybenzoic acids and salts and esters thereof, such as pyrithiobac-sodium, bispyribac-sodium, pyriminobac-methyl and pyribenzoxim.
EE. quinolinecarboxylic acids such as quimerac and quinclorac
FF. herbicide antidotes such as benoxacor, cloquintocet-mexyl, dichlormid, fenchlorazole-ethyl, fenclorim, fluxofenim, furilazole, naphthalic anhydride, oxabentrinil, mefenpyr-diethyl, N-(dichloroacetyl)-1-oxa-4-azaspirobicyclo-(4,5)-decane (AD-67), 3-dichloroacetyl-2,2,5-trimethyloxazolidine (R-29148) and 2-dichloromethyl-2-methyl-1,3-dioxolane (MG-191).
GG. sulfamoylureas such as cyclosulfamuron.
HH. sulfonanilides such as chloransulam-methyl, diclosulam, florasulam, flumetsulam and metosulam.
II. sulfonylureas such as amidosulfuron, azimsulfuron, bensulfuron and esters thereof, chlorimuron & esters eg ethyl ester thereof, chlorsulfuron, cinosulfuron, ethametsulfuron-methyl, flazasulfuron, flupyrsulfuron and salts thereof, halosulfuron-methyl, ethoxysulfuron, imazosulfuron, iodosulfuron, metsulfuron and esters thereof, nicosulfuron, oxasulfuron, primisulfuron & esters eg methyl ester thereof, prosulfuron, pyrazosulfuron-ethyl, rimsulfuron, sulfometuron-methyl, sulfosulfuron, thifensulfuron-methyl, triasulfuron, tribenuron, tribenuron-methyl and triflusulfuron-methyl
JJ. thiocarbamates such as butylate, cycloate, dimepiperate, S-ethyl dipropylthiocarbamate (EPTC), esprocarb, molinate, orbencarb, pebulate, prosulfocarb, thiobencarb, tiocarbazil, tri-allate and vernolate.
KK. triazine herbicides such as ametryn, atrazine, cyanazine, dimethametryn, prometon, prometryn, propazine, simazine, simetryn, terbuthylazine, terbutryn and trietazine.
LL. triazole herbicides such as amitrole.
MM. triazolinones such as carfentrazone-ethyl and sulfentrazone.
NN. triketones such as sulcotrione and mesotrione.
OO. uracils such as bromacil, lenacil and terbacil.

Examples of suitable plant growth regulators that may be used as a further active ingredient in the mixture of the invention may be any compound selected from ancymidol, chlormequat chloride, ethephon, flumetralin, flurprimidol, gibberellic acid, gibberellin A4/gibberellin A7, maleic hydrazide, mepiquat chloride, paclobutrazol, prohexadione calcium, thiadiazuron, trinexapac ethyl and uniconazole.

The present invention also relates to a method of controlling insects, acarines, nematodes or molluscs which comprises applying to a pest, to a locus of a pest, or to a plant susceptible to attack by a pest a combination of cis-jasmone and B; seeds comprising a mixture of cis-jasmone and B; and a method comprising coating a seed with a mixture of cis-jasmone and B.

The present invention also includes pesticidal mixtures comprising a cis-jasmone and a component B in a synergistically effective amount; agricultural compositions comprising a mixture of cis-jasmone and component B in a synergistically effective amount; the use of a mixture of cis-jasmone and component B in a synergistically effective amount for combating animal pests; a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a mixture of cis-jasmone and component B in a synergistically effective amount; a method for protecting crops from attack or infestation by animal pests which comprises contacting a crop with a mixture of cis-jasmone and component B in a synergistically effective amount; a method for the protection of seeds from soil insects and of the seedlings' roots and shoots from soil and foliar insects comprising contacting the seeds before sowing and/or after pre-germination with a mixture of cis-jasmone and component B in a synergistically effective amount; seeds comprising, e.g. coated with, a mixture of cis-jasmone and component B in a synergistically effective amount; a method comprising coating a seed with a mixture of cis-jasmone and component B in a synergistically effective amount; a method of controlling insects, acarines, nematodes or molluscs which comprises applying to a pest, to a locus of a pest, or to a plant susceptible to attack by a pest a combination of cis-jasmone and component B in a synergistically effective amount. Mixtures of cis-jasmone and component B will normally be applied in an insecticidally, acaricidally, nematicidally or molluscicidally effective amount. In application cis-jasmone and component B may be applied simultaneously or separately.

The mixtures of the present invention may provide an improvement in plant vigour, an improvement in plant quality, an improved tolerance to stress factors, and/or an improved yield.

As used herein, ‘improvement in plant vigour’ means that certain traits are improved qualitatively or quantitatively when compared with the same trait in a control plant which has been grown under the same conditions in the absence of the mixture of the invention. Such traits include, but are not limited to, early and/or improved germination, improved emergence, the ability to use less seeds, increased root growth, a more developed root system, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant and/or less inputs needed (e.g. less fertiliser, water and/or labour needed). A plant with improved vigour may have an increase in any of the aforementioned traits or any combination or two or more of the aforementioned traits.

According to the present invention, an ‘improvement in plant quality’ means that certain traits are improved qualitatively or quantitatively when compared with the same trait in a control plant which has been grown under the same conditions in the absence of the mixture of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material, improved carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds) and/or improved seed quality (e.g. for use in following seasons). A plant with improved quality may have an increase in any of the aforementioned traits or any combination or two or more of the aforementioned traits.

According to the present invention, an ‘improved tolerance to stress factors’ means that certain traits are improved qualitatively or quantitatively when compared with the same trait in a control plant which has been grown under the same conditions in the absence of the mixture of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients (e.g. nitrogen and/or phosphorus nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients.

Any or all of the above crop enhancements may lead to an improved yield by improving e.g. plant physiology, plant growth and development and/or plant architecture. In the context of the present invention ‘yield’ includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, more preferred at least 1%, even more preferred at least 2%, still more preferred at least 4%, preferably 5% or more.

The mixtures of the present invention can be used to control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are herein collectively referred to as pests. The pests which may be controlled by the use of the invention compounds include those pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies). The mixtures of the invention are particularly effective against insects, acarines and/or nematodes.

The mixtures of the present invention can also be used to control infestations of non-insect pests. In so doing, detrimental conditions including disease and death of a plant can be achieved. Non-insect pests which can be controlled by mixtures of the present invention include, but are not limited to, phytopathogenic fungi of classes Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they include Ascomycetes classes (e.g. Venturia and Erysiphe, Podosphaera, Monilinia, Uncinula) and Oomycetes classes (e.g. Phytophthora, Pythium, Plasmopara). Activity has been observed against Asian soybean rust (Phakopsora pachyrhizi). Furthermore, mixtures of the present invention can be used to control phytopathogenic bacteria and viruses (e.g. Xanthomonas spp, Pseudomonas spp, Erwinia amylovora and the tobacco mosaic virus).

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, for example insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsine inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example for a truncated toxin is a truncated CryIA(b), which is expressed in the Bt11 maize from Syngenta Seed SAS, as described below. In the case of modified toxins, one or more amino acids of the naturally occurring toxin are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.

2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.

3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.

4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.

5. IPC 531 Cotton from Monsanto Europe S.A. 270-272 Avenue de Tervuren, B-1150 Brussels, Belgium, registration number C/ES/96/02.

6. 1507 Maize from Pioneer Overseas Corporation, Avenue Tedesco, 7 B-1160 Brussels, Belgium, registration number C/NL/00/10. Genetically modified maize for the expression of the protein CryI F for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, including the European corn borer.

Transgenic crops of insect-resistant plants are also described in BATS (Zentrum fur Biosicherheit and Nachhaltigkeit, Zentrum BATS, Clarastrasse 13, 4058 Basel, Switzerland, http://www.bats.ch) Report 2003.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225).

Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Useful plants of elevated interest in connection with present invention are cereals; soybean; rice; oil seed rape; pome fruits; stone fruits; peanuts; coffee; tea; strawberries; turf; vines and vegetables, such as tomatoes, potatoes, cucurbits and lettuce.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of a plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

A further aspect of the instant invention is a method of protecting natural substances of plant and/or animal origin, which have been taken from the natural life cycle, and/or their processed forms against attack of pests, which comprises applying to said natural substances of plant and/or animal origin or their processed forms a combination of cis-jasmone and component B in a synergistically effective amount.

According to the instant invention, the term “natural substances of plant origin, which have been taken from the natural life cycle” denotes plants or parts thereof which have been harvested from the natural life cycle and which are in the freshly harvested form. Examples of such natural substances of plant origin are stalks, leafs, tubers, seeds, fruits or grains. According to the instant invention, the term “processed form of a natural substance of plant origin” is understood to denote a form of a natural substance of plant origin that is the result of a modification process. Such modification processes can be used to transform the natural substance of plant origin in a more storable form of such a substance (a storage good). Examples of such modification processes are pre-drying, moistening, crushing, comminuting, grinding, compressing or roasting. Also falling under the definition of a processed form of a natural substance of plant origin is timber, whether in the form of crude timber, such as construction timber, electricity pylons and barriers, or in the form of finished articles, such as furniture or objects made from wood.

According to the instant invention, the term “natural substances of animal origin, which have been taken from the natural life cycle and/or their processed forms” is understood to denote material of animal origin such as skin, hides, leather, furs, hairs and the like.

A preferred embodiment is a method of protecting natural substances of plant origin, which have been taken from the natural life cycle, and/or their processed forms against attack of pests, which comprises applying to said natural substances of plant and/or animal origin or their processed forms a combination of cis-jasmone and component B in a synergistically effective amount.

A further preferred embodiment is a method of protecting fruits, preferably pomes, stone fruits, soft fruits and citrus fruits, which have been taken from the natural life cycle, and/or their processed forms, which comprises applying to said fruits and/or their processed forms a combination of cis-jasmone and component B in a synergistically effective amount.

The combinations according to the present invention are furthermore particularly effective against the following pests: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta_{—}migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonis (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The amount of a combination of the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of pest to be controlled or the application time.

The mixtures comprising cis-jasmone, and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the cis-jasmone and component B as described above is not essential for working the present invention.

The synergistic activity of the combination is apparent from the fact that the pesticidal activity of the composition of cis-jasmone+component B is greater than the sum of the pesticidal activities of cis-jasmone and component B.

The method of the invention comprises applying to the useful plants, the locus thereof or propagation material thereof in admixture or separately, a synergistically effective aggregate amount of a cis-jasmone and a component B.

Some of said combinations according to the invention have a systemic action and can be used as foliar, soil and seed treatment pesticides.

With the combinations according to the invention it is possible to inhibit or destroy the pests which occur in plants or in parts of plants (fruit, blossoms, leaves, stems, tubers, roots) in different useful plants, while at the same time the parts of plants which grow later are also protected from attack by pests.

The combinations of the present invention are of particular interest for controlling pests in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

The combinations according to the invention are applied by treating the pests, the useful plants, the locus thereof, the propagation material thereof, the natural substances of plant and/or animal origin, which have been taken from the natural life cycle, and/or their processed forms, or the industrial materials threatened by pests, attack with a combination of cis-jasmone and component B in a synergistically effective amount.

The combinations according to the invention may be applied before or after infection or contamination of the useful plants, the propagation material thereof, the natural substances of plant and/or animal origin, which have been taken from the natural life cycle, and/or their processed forms, or the industrial materials by the pests.

The combinations according to the invention can be used for controlling, i. e. containing or destroying, pests of the abovementioned type which occur on useful plants in agriculture, in horticulture and in forests, or on organs of useful plants, such as fruits, flowers, foliage, stalks, tubers or roots, and in some cases even on organs of useful plants which are formed at a later point in time remain protected against these pests.

When applied to the useful plants the cis-jasmone is generally applied at a rate of 1 to 500 g a.i./ha in association with 1 to 2000 g a.i./ha, of a compound of component B, depending on the class of chemical employed as component B.

Generally for plant propagation material, such as seed treatment, application rates can vary from 0.001 to 10 g/kg of seeds of active ingredients. When the combinations of the present invention are used for treating seed, rates of 0.001 to 5 g of a cis-jasmone per kg of seed, preferably from 0.01 to 1 g per kg of seed, and 0.001 to 5 g of a compound of component B, per kg of seed, preferably from 0.01 to 1 g per kg of seed, are generally sufficient.

The weight ratio of cis-jasmone to component B may generally be between 1000:1 and 1:1000.

The invention also provides pesticidal mixtures comprising a combination of cis-jasmone and component B as mentioned above in a synergistically effective amount, together with an agriculturally acceptable carrier, and optionally a surfactant.

Spodoptera preferably means Spodoptera littoralis, Spodoptera exigua and Spodoptera frugiperda. Heliothis preferably means Heliothis virescens and Heliothis zea. Tetranychus preferably means Tetranychus urticae.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least the cis-jasmone together with a compound of component B, and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

### EXAMPLE 1

### Control of Two Spotted Spider Mite Tetranychus urticae on Kidney Beans

A field trial using a plot size of 20 m², 3 replicates and 2 foliar sprays at 500 I/ha at 10 day intervals was assessed for average mite population/20 leaves/plot from 11 evaluation dates from Day 3 to Day 35 after treatment. Data are presented in Table 1:

TABLE 1
percentage pest control

| | % pest control |
|---|---|
| | versus untreated |
| Treatment | check |
| Cis-jasmone 5 gai/hl | 51.00 |
| Abamectin 0.45 gai/hl | 41.22 |
| Abamectin 0.9 g active ingredient/hl | 56.56 |
| Cis-jasmone 5 gai/hl and Abamectin 0.45 gai/hl | 58.89 |

Abamectin at 0.45 gai/hl in mixture with cis-jasmone at 5 gai/hl gave control superior to that achieved with the full commercial rate of abamectin (0.9 gai/hl), offering a synergistic effect and allowing for a reduction in a component B ingredient without compromising pest control.

### EXAMPLE 2

### Control of Currant-Lettuce Aphid Nasonova ribis-nigri on Lettuce

A field trial using plots of 20 plants, 3 replicates and 1 foliar spray was assessed for number of apterous aphids/plant and number of infected plants on Day 4, Day 8, Day 11 and Day 14 after treatment. Data are presented in Tables 2A and 2B. Data for untreated control are an average of four control plots (each 3 replicates; 240 total plants) which were interspersed within the treated plots.

TABLE 2A
Average Number of Aphids per Plant

| | Average Number of Aphids per Plant | | | |
|---|---|---|---|---|
| Treatment | Day 4 | Day 8 | Day 11 | Day 14 |
| Untreated Control | 2.265 | 7.795 | 15.4375 | 21.76 |
| Cis-jasmone 50 gai/hl | 0.57 | 3.28 | 8.02 | 19.25 |
| Thiamethoxam 30 gai/hl | 0.05 | 0.12 | 1 | 2.25 |
| Cis-jasmone 50 gai/hl and | 0.03 | 0.08 | 0.13 | 1.25 |
| Thiamethoxam 30 gai/hl | | | | |

TABLE 2B
Number of Infested Plants

| | Number of Infested Plants (out of 60) | | | |
|---|---|---|---|---|
| Treatment | Day 4 | Day 8 | Day 11 | Day 14 |
| Untreated Control | 40.25 | 54.25 | 59.75 | 60 |
| Cis-jasmone 50 gai/hl | 21 | 48 | 59 | 60 |
| Thiamethoxam 30 gai/hl | 1 | 3 | 15 | 22 |
| Cis-jasmone 50 gai/hl and | 2 | 1 | 4 | 14 |
| Thiamethoxam 30 gai/hl | | | | |

The results show a synergistic effect according to the Colby formula (see Colby, S. R. “Calculating synergistic and antagonistic responses of herbicide combinations”, Weeds, 15, pages 20-22, 1967). Looking at the Day 14 data, the Colby formula predicts a 90.85 percentage control based on the number of aphids counted per plant from the individual treatments, however the mixture of cis-jasmone and Thiamethoxam showed a control of 94.26. From the number of infested plants in each individual treatment the Colby formula would predict 63.33% control, however the actual data from the mixture showed 76.67% control, a synergistic effect of cis-jasmone in mixture with a component B.

### EXAMPLE 3

### Control of Currant-Lettuce Aphid Nasonova ribis-nigri on Lettuce

A field trial using plots of 20 plants, 4 replicates and 1 foliar spray was assessed for number of apterous aphids/plant on Day 3, Day 7 and Day 10 after treatment. Data are presented in Table 3:

TABLE 3
Average Number of Aphids per Plant

| | Average Number of Aphids per Plant | | |
|---|---|---|---|
| Treatment | Day 3 | Day 7 | Day 10 |
| Untreated Control | 4.313 | 6.088 | 12.875 |
| Cis-jasmone at 100 gai/hl | 2.963 | 6.563 | 12.375 |
| Thiamethoxam at 25 gai/hl | 0.063 | 0.788 | 4.813 |
| Thiamethoxam at 25 gai/hl | 0.100 | 0.850 | 3.313 |
| and Cis-jasmone at 100 gai/hl | | | |

This example further shows the beneficial effects of cis-jasmone in a mixture with a component B, here thiamethoxam. The mixture of cis-jasmone 100 gai/hl and thiamethoxam 25 gai/hl gave improved long-term control of aphid pests on lettuce as compared to treatment with Thiamethoxam alone.

### EXAMPLE 4

### Control of Thrips Thrips Tabaci on Cotton

A field trial using 21 m² plots, 3 replicates and 1 foliar spray was assessed for number of adult thrips/plant on Day 1, Day 3, Day 5, Day 8, Day 10, Day 15, and Day 22 after treatment. Data are presented in Table 4. Data for untreated control are an average of four control plots.

TABLE 4
Average Number of Thrips per Plant

| | Average Number of Thrips per Plant | | | | | | |
|---|---|---|---|---|---|---|---|
| Treatment | Day 1 | Day 3 | Day 5 | Day 8 | Day 10 | Day 15 | Day 22 |
| Untreated Control | 38 | 38 | 59 | 70 | 83 | 108 | 57 |
| Cis-jasmone 50 gai/hl | 24 | 19 | 28 | 48 | 58 | 65 | 32 |
| Thiamethoxam 30 gai/hl | 31 | 17 | 27 | 15 | 27 | 52 | 29 |
| Cis-jasmone 50 gai/hl and | 22 | 11 | 18 | 9 | 18 | 36 | 20 |
| Thiamethoxam 30 gai/hl | | | | | | | |

Thus the average number observed across all days monitored was 65 thrips per control plant, versus 39 per cis-jasmone-treated plant and 28 per thiamethoxam-treated plant. The mixture of cis-jasmone and component B had an average of only 19 thrips per plant, a substantial increase in performance compared to component B alone.

### EXAMPLE 5

### Control of Aphid Aphis gossypii on Cotton

A field trial using 21 m² plots, 3 replicates and 1 foliar spray was assessed for number of apterous adults/plant on Day 1, Day 3, Day 5, Day 8, Day 10, Day 15, and Day 22 after treatment. Data are presented in Table 5. Data for untreated control are an average of four control plots.

TABLE 5
Average Number of Aphids per Plant

| | Average Number of Aphids per Plant | | | | | | |
|---|---|---|---|---|---|---|---|
| Treatment | Day 1 | Day 3 | Day 5 | Day 8 | Day 10 | Day 15 | Day 22 |
| Untreated Control | 56 | 87 | 111 | 265 | 309 | 97 | 48 |
| Cis-jasmone 50 gai/hl | 40 | 33 | 45 | 126 | 139 | 27 | 14 |
| Thiamethoxam 30 gai/hl | 41 | 20 | 23 | 26 | 33 | 20 | 10 |
| Cis-jasmone 50 gai/hl and | 42 | 15 | 20 | 11 | 17 | 12 | 6 |
| Thiamethoxam 30 gai/hl | | | | | | | |

Thus the average number observed across all days monitored was 139 aphids per control plant, versus 61 per cis-jasmone-treated plant and 25 per thiamethoxam-treated plant. The mixture of cis-jasmone and thiamethoxam substantially outperformed the thiamethoxam alone, with an average of only 18 aphids per plant. Again, we see cis-jasmone and component B offer advantages in pest control.

### EXAMPLE 6

### Control of Aphid Aphis gossypii on Cotton

A field trial using plots of 20 plants, 3 replicates and 1 foliar spray was assessed for number of alate and apterous aphids/plant from 8 evaluation dates from Day 3 to Day 29 after treatment. Data are presented in Table 6. Data for untreated control are an average of four control plots (each 3 replicates; 240 total plants) which were interspersed within the treated plots.

TABLE 6
Average Number of Aphids per Plant

Average Number of Aphids/Plant

| Treatment | Alate | Apterous |
|---|---|---|
| Untreated control | 25 | 497 |
| Cis-Jasmone 50 gai/hl | 18 | 260 |
| Cyantraniliprole 100 gai/hl | 17 | 235 |
| Cyantraniliprole 200 gai/hl | 16 | 179 |
| Cis-Jasmone 50 gai/hl and | 14 | 142 |
| Cyantraniliprole 50 gai/hl | | |

As is evident from the data, the mixture of cis-jasmone and a component B, here cyantraniliprole, allowed for a reduction in the rate of component B with no reduction (in fact, a notable increase) in pest control.

### EXAMPLE 7

### Control of Phakopsora pachyrhizi on Soybean

Greenhouse experiments were conducted to evaluate the ability of cis-jasmone to enhance fungicidal activity of a single agrochemical active ingredient and also of a mixture of two agrochemical active ingredients. A fungicidally active ingredient, N-[(1RS,4SR)-9-(Dichloromethylidene)-1,2,3,4-tetrahydro-1,4-methanonaphthalen-5-yl]-3-(difluoromethyl)-1-methyl-1H-pyrazole-4-carboxamide (“halo methylene benzonorbornene amide”), alone or in admixture with another fungicidally active ingredient, azoxystrobin, controls soybean rust when applied as a foliar spray. See data in Table 7.

TABLE 7
Percentage Fungicidal Activity

| | Activity, |
|---|---|
| Treatment | % |
| Halo methylene benzonorbornene amide 1 gai/ha | 20 |
| Cis-Jasmone 0.1 gai/ha and Halo methylene | 64 |
| benzonorbornene amide 1 gai/ha | |
| Halo methylene benzonorbornene amide 1 gai/ha | 79 |
| and Azoxystrobin 2 gai/ha | |
| Cis-Jasmone 9 gai/ha and Halo methylene | 99 |
| benzonorbornene amide 1 gai/ha and Azoxystrobin 2 gai/ha | |

As is evident from the data, mixing cis-jasmone with the single fungicidal component B and with the two fungicidal components results in an increase in fungicidal activity.

1. A mixture comprising cis-jasmone and a component B, wherein component B is a diamide selected from the group consisting of flubendiamide, chlorantraniliprole and cyantraniliprole.

2. The mixture according to claim 1, wherein component B is cyantraniliprole.

3. The mixture according to claim 1, wherein component B is chlorantraniliprole.

4. The mixture according to claim 1, wherein the mixture comprises a further active ingredient selected from ancymidol, chlormequat chloride, ethephon, flumetralin, flurprimidol, gibberellic acid, gibberellin A4/gibberellin A7, maleic hydrazide, mepiquat chloride, paclobutrazol, prohexadione calcium, thiadiazuron, trinexapac ethyl and uniconazole.

5. The mixture according to claim 4, wherein the further active ingredient is trinexapac ethyl.

6. The mixture according to claim 1, wherein the mixture comprises an agricultural acceptable carrier and optionally a surfactant.

7. The mixture according to claim 1, wherein the weight ratio of cis-jasmone to component B is selected from at least one of 1000:1 to 1:1000 and 100:1 to 1:100.

8. A seed comprising a mixture as defined in claim 1.

9. A method of controlling insects, acarines, nematodes or molluscs which comprises applying to a pest, to a locus of a pest, or to a plant susceptible to attack by a pest a combination of cis-jasmone and component B, wherein component B is as defined in claim 1.

10. The method of claim 9, wherein component B is chlorantraniliprole.

11. The method of claim 9, wherein component B is cyantraniliprole.

12. The method of claim 9, wherein the pest is an insect pest.

13. The method of claim 9, wherein the plant is turf.
